(19) United States
(12) Patent Application Publication
(10) Pub. No.: US 2012/0054675 A1
(43) Pub. Date: Mar. 1, 2012

(54) GRAPHICAL USER INTERFACE SYSTEM FOR A LOG ANALYZER

(75) Inventors: Seshadri Rajamannar, Bangalore (IN); Raghavendra Marutirao Banappanavar, Bangalore (IN); Kumar Swamy BV, Bangalore (IN)

(73) Assignee: UNISYS CORPORATION, Blue Bell, PA (US)

(21) Appl. No.: 12/900,536

(22) Filed: Oct. 8, 2010

(30) Foreign Application Priority Data
Aug. 26, 2010 (IN) 2026/DEL/2010

(51) Int. Cl. G06F 3/048

(52) U.S. Cl. 715/809

(57) ABSTRACT

A graphical user interface system for a log analyzer having an input module, an output module, a merge module, and an export module. The input module selects one or more log files, and the output module displays the selected log files for analysis. The merging module performs time normalization for two or more log files from the selected log files, and merges the normalized log files. The export module can then export the merged log files.

### FIELD

This application deals generally with data logs, and more particularly with managing and analyzing data logs.

### BACKGROUND

Typically, data logging is a process of recording events using an automated computer program. During data logging, an event log service records application, security, and system events for providing information regarding hardware, software, and system components. The event logs can help users identify and diagnose the source of system problems. In addition, the event logs can also be used to predict potential system problems. The description of recorded event logs is typically included in log files. To predict the potential problems and to locate the source of the existing problems, analyzing log files becomes important.

Commonly, a log analyzer queries the log files and performs various analytical functions on the logged data using a Structured Query Language (SQL) query. The user can provide instructions to the log analyzer regarding the requisite information and various processing techniques using the query. The results of the query can be custom-formatted in text-based output, or they can be persisted to specialty targets like charts, or the like. Most existing log analyzers are not user-friendly, as the user needs to type or otherwise enter the desired SQL query in a Disk Operating System (DOS) prompt or other such cumbersome user interface. In addition, SQL is a complex language, rendering reading and managing the log files, as well as performing functions on them, difficult.

Clearly, analyzing a single log file can be a cumbersome and difficult prospect, requiring significant training before a user can become competent. The level of difficulty increases significantly on today's complex systems in which various types of equipment, operating systems, applications, and the like interact, many of which keep their own log files. Conventional log analyzers are unable to combine the log files from these different sources into a single, easily analyzed list. Instead, the user is required to display the log files from different systems separately, making the analysis cumbersome.

### SUMMARY

There has been a long-felt need for a user-friendly interface to analyze log files, and especially an interface which obviates the need to enter complex queries through a command line such as that disclosed herein. The instant disclosure also recognizes that it can be advantageous for a user to view the log files from different systems in a correlated, integrated sequence.

The instant application discloses a graphical user interface system for a log analyzer. The interface system includes an input module, an output module, a merge module, and an export module. The input module selects one or more log files, and the output module displays the selected log files for analysis. The merge module performs time normalization for two or more log files from the selected log files, and merges the normalized log files. The export module can then export the merged log files.

The instant application also discloses a computer-implemented method for operating a graphical user interface system for a log analyzer. The method includes activating an input module for selecting one or more log files, and displaying the selected log files for analysis in an output module. Further, the method includes activating a merge module for performing time adjustment and normalization on two or more log files from the selected log files and merging the normalized log files. Thereafter, the method includes activating an export module for exporting the merged log files.

### BRIEF DESCRIPTION OF THE DRAWINGS

The figures described below and attached hereto set out and illustrate a number of exemplary embodiments of the disclosure. Throughout the drawings, like reference numerals refer to identical or functionally similar elements. The drawings are illustrative in nature and are not drawn to scale.

FIG. 1 illustrates an exemplary log analyzer.

FIG. 2 illustrates an exemplary embodiment of a graphical user interface system for the log analyzer of FIG. 1.

FIGS. 3-8 illustrate exemplary methods for analyzing log files.

### DETAILED DESCRIPTION

The following detailed description is made with reference to the figures. Exemplary embodiments are described to illustrate the subject matter of the disclosure, not to limit its scope, which is defined by the appended claims.

### Overview

In general, the present disclosure describes a computer-implemented platform to analyze log files. In some embodiments, the platform may comprise computer readable instructions, tangibly stored on one or more computer readable media, which cause a processor within a computing device to perform a set of steps. The platform allows users to analyze log files in ways other than typing a Structured Query Language (SQL) query in a Disk Operating System (DOS) prompt. The platform of the present disclosure provides an interface system having graphical icons, such as buttons and various visual indicators, such as pop-up boxes to represent the information and actions available to the user. Also, the platform of the present disclosure automatically performs the functions involved in log analysis, such as time-adjustment, filtering log files, and the like. In addition, the platform provides a capability to merge log files from different systems.

### Exemplary Embodiments

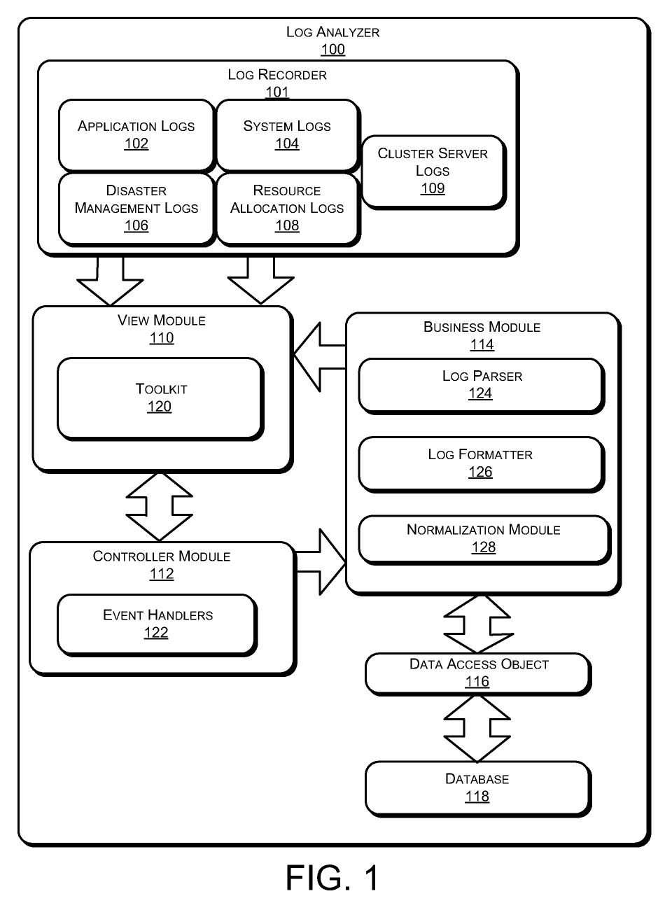

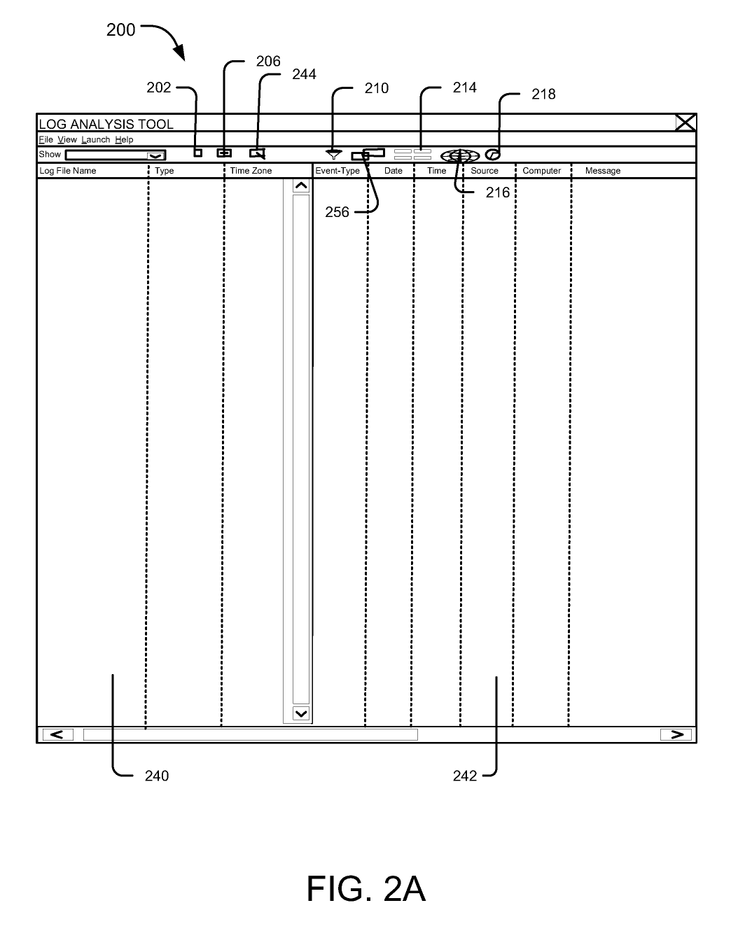

FIG. 1 illustrates an exemplary log analyzer 100 utilized in a conventional computer system. The computer system includes a processor, memory, and peripheral devices such as a display screen, a keyboard, and a pointing device. The log analyzer 100 includes a log recorder 101 having files corresponding to one or more type of logs such as, without limitation, application logs 102, system logs 104, disaster management logs 106, resource allocation logs 108, and cluster server logs 109 (hereinafter the different type of logs will be collectively referred to as logs 102-109). The logs 102-109 include one or more log files. The application logs 102 include events logged by programs. For example, a database program may record a file error in the application log 102. Similarly, the system logs 104 include events logged by system components. For example, if a driver fails to load during startup, an event is recorded in the system log 104.

The disaster management logs 106 include events logged during replication of data for disaster recovery during network failure, and the like. The data may be replicated within the same site, to a remote site, or both. Further, the resource allocation logs 108 include events logged during real-time allocation of resources to computer applications and users that need them, and facilitate continually monitoring service levels to ensure business performance is on target.

The cluster server logs 109 log events while guarding against application and service failures, system and hardware failures, and site failures. The application and service failures affect application software and essential services. The system and hardware failures affect hardware components such as CPUs, drives, memory, network adapters, power supplies, and site failures. These failures can be caused by natural disasters, power outages, or connectivity outages.

Although illustrated and disclosed as separate logs, it should be apparent to one skilled in the art that some of these disparate logs may be stored in a single database. Similarly, although illustrated as log files occurring on a single computer, it should be apparent to one skilled in the art that log files from a plurality of computing systems may be combined using the disclosed platform without departing from the spirit or the scope of the disclosure.

The log analyzer 100 also includes a view module 110, a controller module 112, a business module 114, a Data Access Object (DAO) 116, and database 118. The user interacts with the log analyzer 100 via the view module 110, which embodies a toolkit 120 for use in designing applications with graphical user interfaces (GUI). In one embodiment, the log analyzer 100 may utilize JAVA™ Swing as an application-programming interface (API) for providing the GUI; alternatively, other suitable high level programming language such as VB.Net™ may also be used. The controller module 112 includes event handlers 122 for handling inputs received from the GUI. Exemplary events received by the controller module 112 from the GUI include, without limitation, key presses, mouse movement, and action selections.

Both the view module 110 and the controller module 112 interact with the business module 114. More specifically, the business module 114 receives input from the controller module 112 and transmits output to the view module 110. In the embodiment illustrated in FIG. 1, the business module 114 includes a log parser 124, a log formatter 126, and a normalization module 128. The log parser 124 includes functional units corresponding to each of the logs 102-109. Each functional unit is used to parse the corresponding logs. Specifically, the log parser 124 scans the information stored in each of the logs 102-109, and displays a message to the user if there is an error in the scanning.

It will be evident to a person skilled in the art that the information is stored in different order in each of the logs 102-109. By way of example, without limitation, date-time stamp may be stored in second column in the application logs 102, whereas in the cluster server logs 109, the same information may appear in first column. The log formatter 126 places the information, corresponding to same fields, from different columns across the different logs 102-109 under a single header. In some embodiments, the log formatter 126 can delete information that is not required for the analysis.

In the embodiment illustrated in FIG. 1, the normalization module 128 normalizes the date-time stamp of each of the log files. The normalization module 128 can standardize the time of the log files to a 24-hour format. Similarly, the date of the record can be standardized to Year/Month/Date format with milliseconds offset. By way of example, without limitation, the normalization module 128 may normalize Date/Month/Year 12-hour format of the log files of the application logs 102 in Year/Month/Date 24-hour format with milliseconds offset.

The business module 114 also interacts with the DAO 116, which provides simplified access to data stored in a database, such as the database 118. The DAO 116 collects the information required for analysis from the business module 114 and stores the collected information in the database 118 in a particular format, with similar information typically stored under the same header. The user can thus interact with the log analyzer 100 to analyze a consolidated version of the various log files by using an interface system via the view module 110.

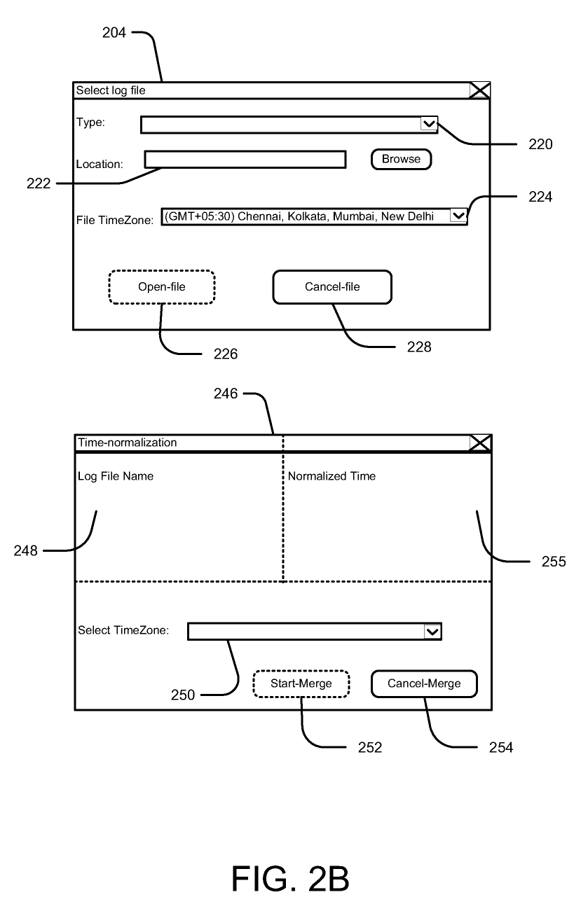

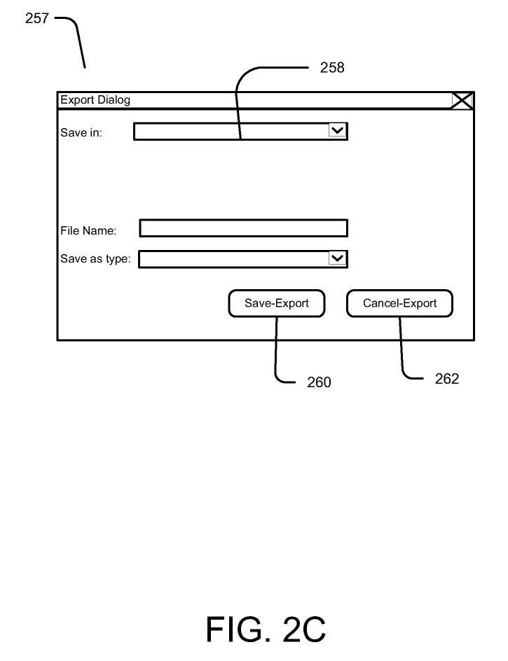

FIG. 2A illustrates an exemplary interface system, such as a graphical user interface system 200, for interacting with the log analyzer 100. The interface system 200 enables a user to analyze the various log files and perform various functions such as filtering log files, performing time-adjustment thereof, and the like.

In the embodiment illustrated in FIG. 2, the interface system 200 includes a plurality of user interface elements, or input modules, such as an open module 202, a select module 204 (FIG. 2B), a clear module 206, a filter module 210, a tile-view module 214, a time-zone module 216, and a time-adjustment module 218 displayed thereon. Both the open module 202 and the select module 204 select one or more log files for display from the log recorder 101. The open module 202, when selected, initiates display of the select module 204.

As illustrated in FIG. 2B, the select module 204 includes a type module 220, a location module 222, and a file time-zone module 224. The select module 204 allows the user to select the type of log files to be displayed using the type module 220. The type of log files selected for display may include files corresponding to, without limitation, the application logs 102, the system logs 104, the disaster management logs 106, the resource allocation logs 108, or the cluster server logs 109. The select module 204 also allows a user to specify a location of one or more log files using the location module 222, and specify a time zone using the file time-zone module 224.

In the present embodiment, the open module 202 is an interactive graphical icon and the select module 204 is a pop-up window. In addition, the type module 220, the location module 222, and the file time-zone module 224 may be embodied as drop-down menus. Although the user interfaces of the present disclosure are illustrated as comprising drop-down boxes, menus, and buttons, other type of user interface elements, such as radio-buttons, check boxes, and the like, may be utilized without departing from the spirit or the scope of the disclosure.

The select module 204 also includes an open-file module 226 and a cancel-file module 228 displayed thereon. The cancel-file module 228, when selected, closes the select module 204. Selection of the open-file module 226, when such module is active, allows the user to cause the selected log files to be displayed in the user interface system 200. In some embodiments, the open-file module 226 is activated when data is received in at least one of the type, location, and file time-zone modules 220, 222, and 224. In some embodiments, the type and time-zone information may be auto-populated based on metadata associated with, or data stored in, the selected log file(s)

The clear module 206, the filter module 210, the tile-view module 214, the time-zone module 216, and the time-adjustment module 218 activate log analysis functions for clearing the log files, filtering the log files, activating tile-view display, selecting time-zone for the log files, and performing time-adjustment for the log files, respectively. After the open and select modules 202 and 204 open the log files for display, the clear module 206 switches from inactive to active state. In the active state, the clear module 206 can be selected to remove one or more of the log files displayed on the interface system 200. The filter module 210 filters the log files based on one or more filtering criteria selected from a set of defined filtering criteria. In some embodiments, such filtering criteria may include, without limitation, an error event, an information event, a warning event, and an unknown event.

By way of illustration, without limitation, the error event may comprise an event describing a significant problem, such as failure of a critical task. The error event may involve data loss or loss of functionality. For example, the error event may be logged if a service fails to load during startup. The information event describes successful operation of a task, such as an application, driver, or service. For example, the information event may be logged when a network driver loads successfully. The warning event indicates the possible occurrence of a future problem. For example, disk space running low may trigger the warning event. Events that cannot be classified as error, information, or warning events may be classified as unknown events.

The tile-view module 214 divides the interface system 200 into a plurality of sections and enables the user to view at least a subset of the loaded log files separately in each section. The time-zone module 216, when selected, opens a time-zone window having one or more time zones, thereby enabling the user to change the time zone of the selected log file(s) to a target time zone. Similarly, the time-adjustment module 218, when active, enables the user to select the time-adjustment module 218 to adjust the time ahead or behind for the selected log file(s).

The interface system 200 also includes output modules such as a log-display module 240, and a detail-display module 242. In one embodiment, the log-display module 240 and the detail-display module 242 may be embodied as scrollable lists. Other types of display modules such as cascading tree views, drop-down lists, or the like may also be employed, instead of the scrollable lists, without departing from the scope of the disclosure.

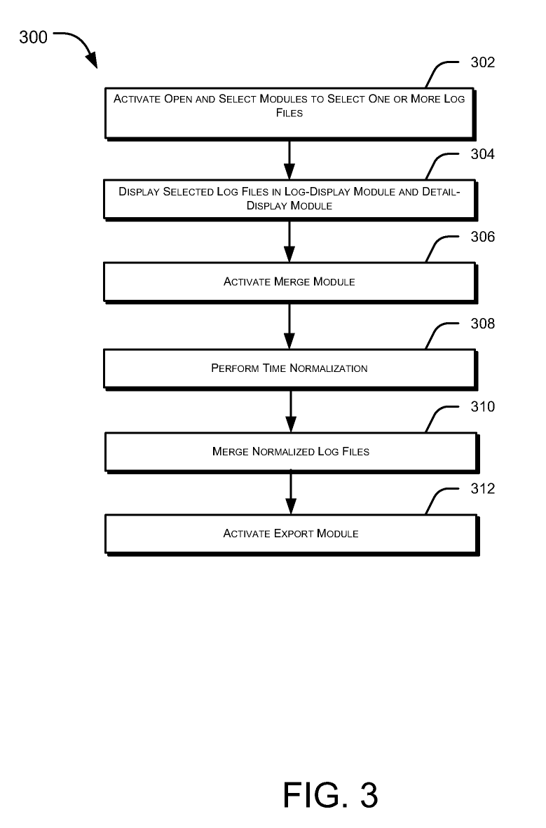

In the illustrated embodiment, the log-display module 240 displays the log files selected for analysis by the open and select modules 202 and 204, while the detail-display module 242 show various details of the displayed log files. Specifically, the log-display module 240 displays “log file name,” “type,” and “time-zone” for the selected log files. The “type” indicates whether the selected log files correspond to application, system, disaster management, resource allocation, or cluster server logs 102-109. The detail-display module 242 may display other fields associated with the selected log files such as “event type,” “date,” “time,” “source,” “computer,” and “message”. The “event type” field indicates the type of event (error, information, warning, or unknown event); and “date” and “time” fields indicate the date and time on which the log event occurred. The field “source” relates to the source of the event such as name of a program, a system component, or an individual component of a large program; and the “computer” field indicates the name of the computer where the event occurred. In addition, the field “message” relates to the description of the log events. The functionality of the output modules are explained in detail in conjunction with FIGS. 3-8.

The interface system 200 also includes a merge module 244. The merge module 244 is for use in displaying two or more log files from different systems in a correlated and integrated time sequence. Specifically, the activated merge module 244, when selected, invokes a time-normalization module 246 (FIG. 2B). As illustrated in FIG. 2B, the time-normalization module 246 includes a first section 248, a select-timezone module 250, a start-merge module 252, a cancel-merge module 254, and a second section 255. The time-normalization module 246 displays the log files selected for merging in the first section 248. The select-timezone module 250 allows the user to select a time for changing timestamps of the log files selected for merging. The selected time may be reflected in the second section 255, and the selection of the target time activates the start-merge module 252, thereby allowing the user to click the start-merge module 252 to initiate time normalization. It will be evident that any suitable algorithm, including addition and subtraction functions, known in the art may be utilized to change the timestamp of the selected log files to the target time. Thereafter, the selected log files are merged and arranged in a time sequence in the detail-display module 242. The cancel-merge module 254, when active, allows users to cancel the display of the time-normalization module 246.

FIG. 2A also illustrates an export module 256, displayed on the interface system 200 (FIG. 2A), which enables the user to save the merged log files at a specified location. The export module 256, when selected, invokes an export dialog 257 (FIG. 2C). As illustrated in FIG. 2C, the export dialog 257 includes a save-in module 258, a save-export module 260, and a cancel-export module 262. The user can select or type the file-saving location in the save-in module 258. The save-export module 260, when selected, allows users to save the merged log files at the specified location. Similarly, the cancel-export module 262, when selected, allows the user to close the export dialog 257. It will be evident that although illustrated with text boxes, drop-down menus, and buttons, other types of user interface elements may be utilized, including, without limitation, scrollable lists, check boxes, radio boxes, and the like, without departing from the spirit or the scope of the disclosure.

In one implementation, the interface system 200 having the input modules 202-218, the output modules 240 and 242, the merge module 244, and the time-normalization module 246 are configured using JAVA™ programming. JAVA™ Swing provides interactive features that can be used to develop the interface system 200. Those skilled in the art will understand that the GUI may be implemented using any other high-level programming language such as VB.Net™ without departing from the scope of the disclosure.

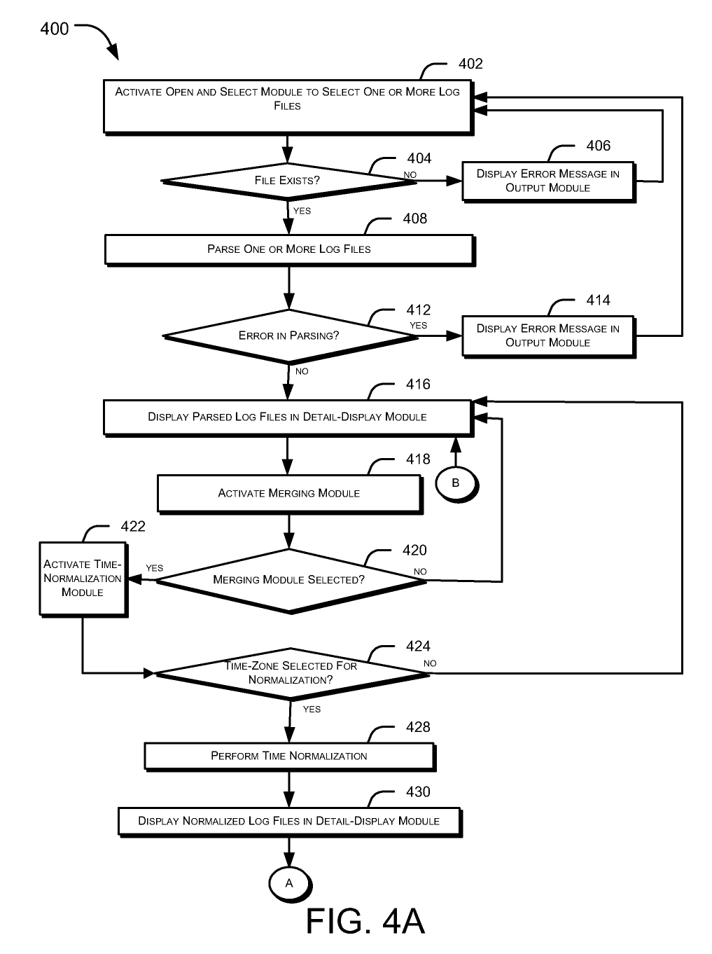

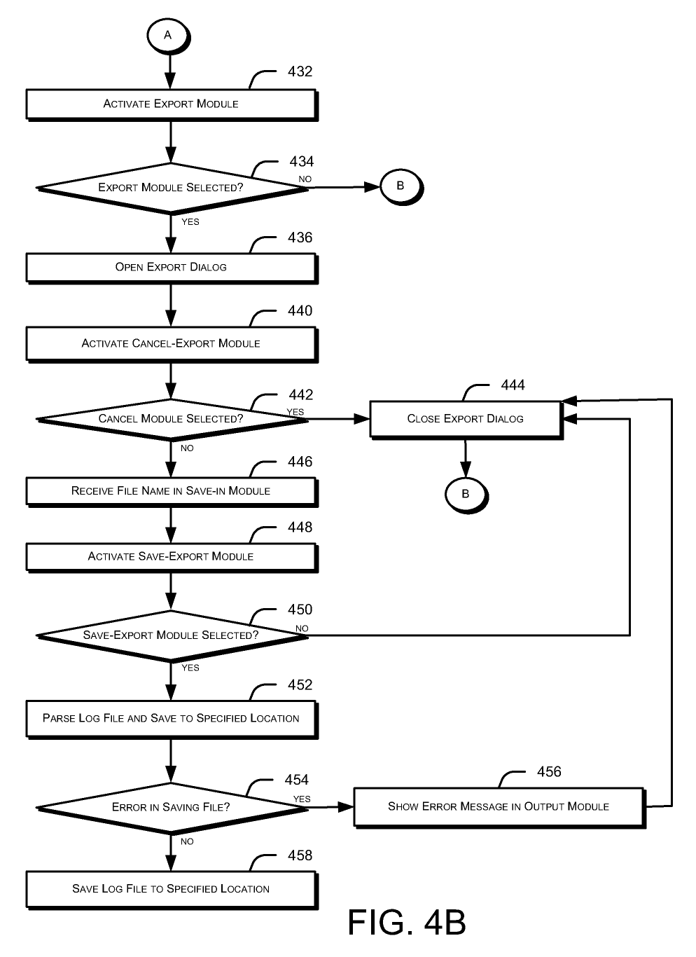

FIG. 3 is a flowchart illustrating a method 300 to merge two or more log files using the interface system 200. The method 300 begins at block 302, which activates the open modules 202 and causes the display of the select module 204 for selecting one or more log files. The selected log files are displayed in the log-display module 240 and the detail-display module 242 at block 304. In the illustrated embodiment, two or more log files are selected from the displayed log files, and block 306 activates the merge module 244. Block 308 performs time normalization on the log files selected for merging. The normalized log files are merged at block 310. Once the log files are merged, the export module 256 can be activated at block 312. The method 300 of FIG. 3 is explained in more detail in FIGS. 4A and 4B.

FIGS. 4A and 4B are flowcharts explaining the merging of the log files in detail. The method 400 begins at block 402, which activates the open module 202 and causes the select module 204 to be displayed to facilitate the user selecting log files. As an example, to select the log files, the user positions a pointing device's cursor over the open module 202, and depresses the pointing device's button to select the open module 202. The selection of the open module 202 causes the display of the select module 204. The user selects the type of log file for display using the pointing device or enters the requisite type in the type module 220. The location of the selected log file is reflected in the location module 222. Alternatively, the user can browse the corresponding location. The user can also select the time zone for the selected log file using the file time-zone module 224. In addition, the user may select the open module 202 by positioning the pointing device's cursor on “File” option (illustrated in FIG. 2A), opening the “File” option, and selecting an “open” option. It will be evident that although the use of a pointing device is described throughout the instant disclosure, a keyboard, touch screen, or other human/computer interface device may be substituted therefor without departing from the spirit or the scope of the disclosure.

Block 404 determines whether the selected log file is stored at the location specified in the location module 222. If the log file is not present, block 404 leads to block 406 for displaying an error message in an output module such as a pop-up box, and block 406 returns to block 402.

Otherwise, block 404 leads to block 408, which parses the selected log files. In some embodiments, block 408 selects log file data corresponding to the “event type,” “date,” “time,” “source,” “computer,” and “message” fields. Block 412 determines if an error is encountered during parsing the selected log files. If an error is encountered, block 412 leads to block 414. Block 414 displays an error message in an output module such as a pop-up window, and returns to block 402. If no error is encountered, block 412 leads to block 416 for displaying information corresponding to the parsed fields in the detail-display module 242.

Block 416, which displays the selected log files in the detail-display module 242, leads to block 418 for activating the merge module 244. The user then selects two or more log files and depresses the pointing device's cursor on the merge module 244. Alternatively, the user may select two or more log files and from a context-based menu (e.g., one displayed by the user “right-clicking” on the selected log files) or from the menu bar.

Block 418 leads to block 420, which determines whether the user selects the merge module 244. If it is determined that the merge module 244 is not selected, block 420 returns to block 416; otherwise, block 420 leads to block 422 for activating the time-normalization module 246. The activation of the time-normalization module 246 enables the user to select the time zone for normalizing the two or more log files. Thereafter, block 424 determines if the user selects a particular time zone for the time-normalization. If no time zone is selected, block 424 returns to block 416. Otherwise, block 424 leads to block 428, which adjust the timestamp of the two or more log files, selected for merging, to the selected time zone as they are read. In block 430, the normalized log files are displayed in an integrated, correlated time sequence in the detail-display module 242. Block 430 leads to a connector A.

FIG. 4B is a continuation of FIG. 4A, as depicted by the connector A. As illustrated in FIG. 4B, block 430 leads to block 432 via the connector A. Upon merging of the log files in correlated and integrated sequence, block 432 activates the export module 256, enabling the user to select the export module 256 using the pointing device, and the like. Block 434 determines if the user selects the export module 256. If it is determined that the export module 256 is not selected, block 434 returns to block 416 as indicated by connector B; otherwise, block 434 leads to block 436. Block 436 opens the export dialog 257 for exporting the merged log files. The opening of the export dialog 257 activates the cancel-export module 262 at block 440, enabling the user to select the cancel-export module 262. Block 442 determines if the user selects the cancel-export module 262. If it is determined that the user selects the cancel-export module 262, block 442 leads to block 444 to close the export dialog 257 and return to block 416 via the connector B. Otherwise, block 442 leads to block 446 for receiving file name in the save-in module 258 to save the merged log files. Once the file name is received, block 448 activates the save-export module 260, thereby enabling the user to select the save-export module 260. Block 450 checks if the user selects the save-export module 260. If it is determined that the save-export module 260 is not selected, block 450 returns to block 444.

Otherwise, block 450 leads to block 452, which parses the merged log files and saves to the location specified in the save-in module 258. If there is an error in saving the merged log files as determined at block 454, block 456 displays an error message and returns to block 444. Otherwise, block 454 leads to block 458, which saves the merged log files to the specified location.

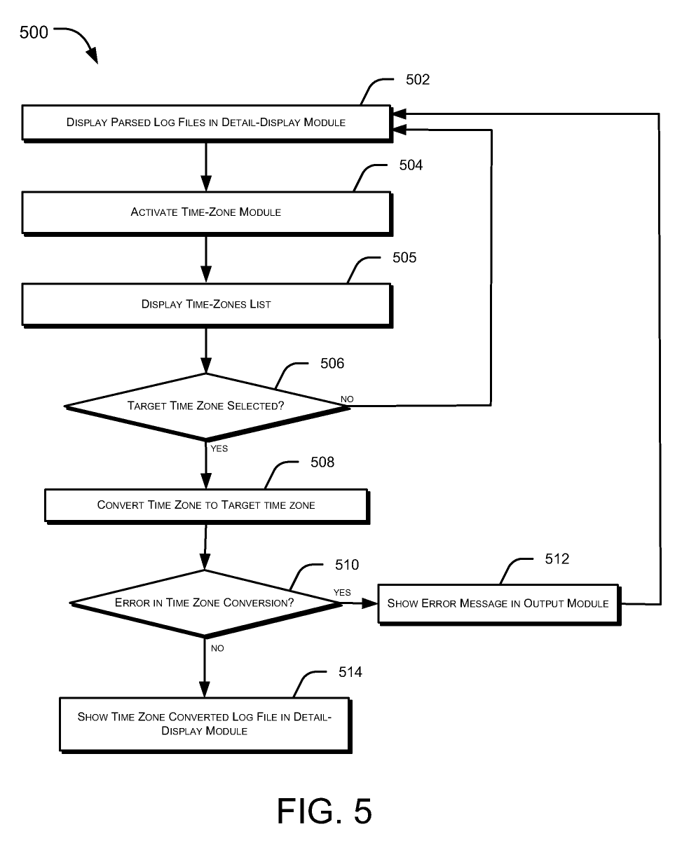

Apart from merging, various other log analysis functions, such as searching, filtering, and the like may be performed once the log files are displayed in the detail-display module 242. The other log analysis functions are explained in conjunction with FIGS. 5-8.

FIG. 5 illustrates a method 500 for selecting time zone for the displayed log files. The method 500 begins at block 502, which displays the parsed log files in the detail-display module 242. Block 504 activates the time-zone module 216 to allow the user to select a target time zone for the displayed log files. As an example, the user positions the pointing device's cursor on the activated time-zone module 216 and depresses the pointing device thereon, thereby triggering an event. The triggering of the event opens a pop-up window, displaying a list of available time zones at block 505. The user may select one or more time zones from this list.

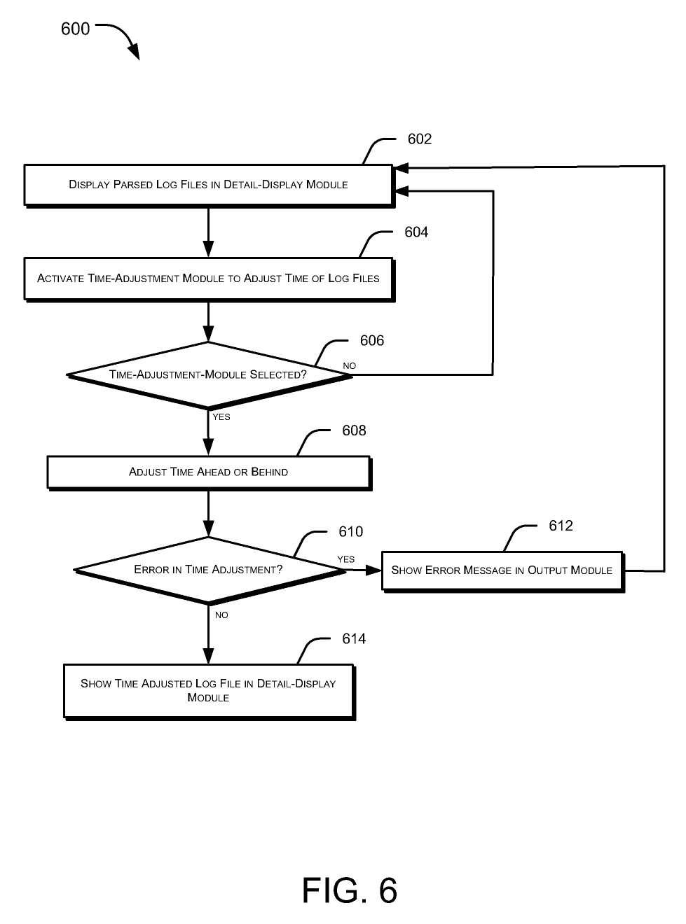

Block 506 determines whether the target time zone is selected by the user. If the target time zone is selected, block 508 converts the time zone of the displayed files to the target time zone; otherwise, block 506 returns to block 502. Block 508 leads to block 510 for determining if there is an error in the conversion of the time zone to the target time zone. If error exists, block 510 leads to block 512 for displaying an error message in an output module such as a pop-up menu. Block 512 returns to block 502, displaying the log files in the detail-display module 242. Otherwise, block 510 leads to block 514, which displays the time zone adjusted log files in the detail-display module 242. Also, the time of the displayed log files can be adjusted as illustrated in FIG. 6.

FIG. 6 illustrates a method 600 for adjusting time of the displayed log files. The method 600 begins at block 602, which displays the parsed log files in the detail-display module 242. Block 604 activates the time-adjustment module 218 to allow the user to adjust the time for the displayed log files. Block 606 determines whether the user selects the time-adjustment module 218. If the user selects the time-adjustment module 218, block 608 adjusts the time of the displayed log files by adjusting hours, minutes, and seconds corresponding to the displayed log files ahead or behind as per the user's selection. Block 608 changes the time of the displayed log files by using addition or subtraction algorithm known in the art.

Block 608 leads to block 610 for determining if there is an error in the conversion of the time to the target time. If error exists, block 610 leads to block 612 for displaying an error message in an output module such as a pop-up menu. Block 612 returns to block 602, displaying the log files in the detail-display module 242. Otherwise, block 610 leads to block 614, which displays the time adjusted log files in the detail-display module 242. Apart from adjusting time of the displayed log files, the tile-view may be activated for displaying the log files in the tile-view format in the detail-display module 242.

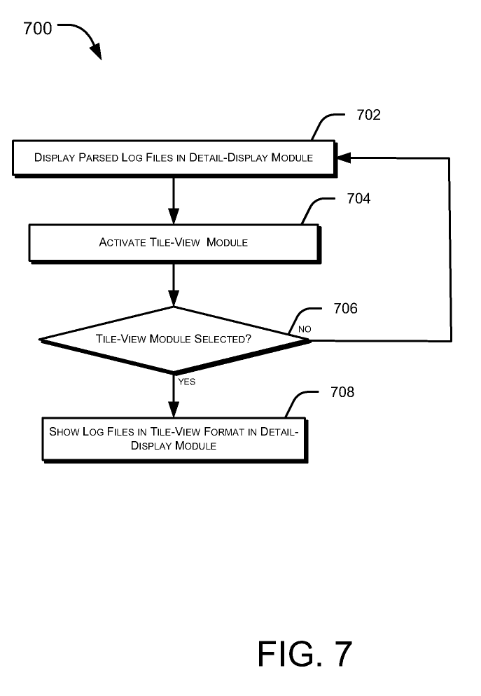

FIG. 7 illustrates a method 700 for viewing the displayed log files in a tile-view format. The method 700 begins at block 702, which displays the parsed log files in the detail-display module 242. Block 704 activates the tile-view module 214. Block 704 leads to block 706, which checks if the user selects the tile-view module 214. If the tile-view module 214 is not selected, block 706 returns to block 702. Otherwise, block 706 divides the detail-display module 242 in a plurality of sections, enabling the user to view a subset of the log files separately in each section. In addition, the displayed log files can be filtered based on the filtering events.

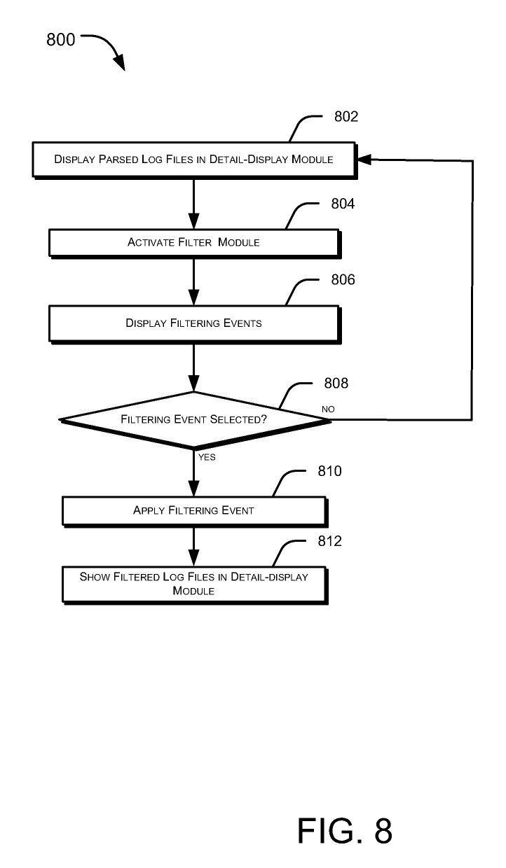

FIG. 8 illustrates a method 800 for filtering the displayed log files in accordance with the filtering events. The method 800 begins at block 802, which displays the parsed log files in the detail-display module 242. Block 804 activates the filter module 210. As an example, the user depresses the pointing device's cursor on the activated filter module 210, thereby initiating display of the filtering criteria/events at block 806. Also, the user can select a filtering criteria/event from a displayed set of defined filtering criteria/events. Block 808 determines if the user selects a filtering criteria/event. If no filtering criteria/event is selected, block 808 returns to block 802. Otherwise, block 808 leads to block 810. Block 810 applies the filtering criteria/event and selects the log files corresponding to the applied filtering event. Block 810 leads to block 812 to display the filtered log files in the detail-display module 242.

Those skilled in the art will understand that the system and methods set out in the discussion above may be combined or altered in specific adaptations of the disclosure. The illustrated system and methods are set out to explain the illustrated embodiments, and it should be anticipated that ongoing technological development would change the manner in which particular functions are performed. These depictions do not limit the scope of the disclosure, which is determined solely by reference to the appended claims.

### CONCLUSION

The present disclosure provides the graphical user interface system 200 and the computer-implemented methods 300, 400, 500, 600, and 700 for analyzing log files and performing various actions thereof. The systems and methods disclosed herein provide a user-friendly manner of analyzing the log files, without the need of typing various SQL queries related to the functions of log analysis. Also, the system allows displaying the log files from different systems in a correlated and integrated time sequence.

The specification sets out a number of specific exemplary embodiments, but persons of skill in the art will understand that variations in these embodiments will naturally occur in the course of embodying the subject matter of the disclosure in specific implementations and environments. For example, any other interactive icons may be employed in the graphical user interface system, apart from those explained in the present disclosure. It will further be understood that such variations, and others as well, fall within the scope of the disclosure. Neither those possible variations nor the specific examples set above are set out to limit the scope of the disclosure. Rather, the scope of claimed disclosure is defined solely by the claims set out below.

What is claimed is:

1. A graphical user interface system for a log analyzer, the system comprising:
an input module configured to select one or more log files;
an output module configured to display the selected log files for analysis; and
a merge module configured to:
perform time normalization for two or more log files from the selected log files; and
merge the normalized log files; and
an export module configured to export the merged log files.

2. The graphical user interface system of claim 1, wherein the input module is further configured to perform at least one of:
selecting time-zone for the selected log files,
adjusting time for the selected log files,
filtering the selected log files, or
clearing the selected log files.

3. The graphical user interface system of claim 1, wherein the output module is further configured to display detailed view for the selected log files.

4. The graphical user interface system of claim 1 further comprises a tile-view module configured to display the selected log files in a tile-view format.

5. The graphical user interface system of claim 1, wherein each of the input module, the output module, the merge module, and the export module comprises an interactive event-driven icon.

6. The graphical user interface system of claim 5, wherein the interactive event-driven icon comprises at least one of a pop-up menu, or a scroll-menu.

7. The graphical user interface system of claim 1, wherein the selected log files comprise at least one of an application log file, a system log file, a cluster server log file, a disaster management log file, and a resource allocation log file.

8. The graphical user interface system of claim 1, wherein the input module is further configured to filter the selected log files based on a set of filtering events.

9. The graphical user interface system of claim 8, wherein the set of filtering events comprises at least one of an error event, an information event, a warning event, or an unknown event.

10. The graphical user interface system of claim 1, wherein the log files are selected across one or more systems.

11. A computer-implemented method for operating a graphical user interface system for a log analysis tool, the method comprising:
activating an input module for selecting one or more log files;
displaying the selected log files for analysis in an output module; and
activating a merge module for:
performing time normalization on two or more log files from the selected log files; and
merging the normalized log files; and
activating an export module for exporting the merged log files.

12. The computer-implemented method of claim 11 further comprising step of displaying the selected log files in a tile-view format.

13. The computer-implemented method of claim 11 further comprising step of selecting time-zone of the selected log files.

14. The computer-implemented method of claim 11 further comprising step of adjusting the time zone of the selected log files.

15. The computer-implemented method of claim 11 further comprising step of clearing the selected log files.

16. The computer-implemented method of claim 11 further comprising step of filtering the selected log files based on a set of filtering events, wherein the set of filtering events comprises at least one of an error event, an information event, a warning event, or an unknown event.

17. The computer-implemented method of claim 11 further comprising step of displaying detailed view for the selected log files.

18. The computer-implemented method of claim 11, wherein the step of selecting the log files comprises selecting at least one of an application log file, a system log file, a cluster server log file, a disaster management log file, and a resource allocation log file.

19. The computer-implemented method of claim 11, wherein the step of activating the input module for selecting log files for analysis comprises activating at least one of an interactive event-driven icon.

20. The computer-implemented method of claim 11, wherein the step of activating the input module for selecting the log files comprises selecting the log files from across one or more systems.

21. A graphical user interface system for a log analyzer, the system comprising:
a set of input modules configured to:
select one or more log files;
select time zone for the selected log files;
execute time-adjustment for the selected log files;
filter the selected log files; or
clear the selected log files;
a set of output modules configured to:
display the selected log files for analysis; or
display detailed view for the selected log files; and
a merge module configured to:
perform time normalization for two or more log files from the selected log files; and
merge the normalized log files; and
an export module configured to export the merged log files.
